(19) United States
(12) Patent Application Publication
(10) Pub. No.: US 2015/0145334 A1
(43) Pub. Date: May 28, 2015

(54) Systems and Methods for Dynamic Voltage Control

(71) Applicant: Marvell World Trade Ltd., St. Michael (BB)

(72) Inventors: Jian Xiong, Shanghai (CN); Wilbur Wang, Shanghai (CN); Wei Huang, Beijing (CN); Xikai Zhao, Fremont, CA (US); Zhoujie Wu, Shanghai (CN); Xiaoguang Chen, Shanghai (CN)

(21) Appl. No.: 14/541,824

(22) Filed: Nov. 14, 2014

Related U.S. Application Data
(60) Provisional application No. 61/908,421, filed on Nov. 25, 2013.

(51) Int. Cl. G06F 1/26

(52) U.S. Cl. CPC G06F 1/26
USPC 307/31

(57) ABSTRACT

System and methods are provided for dynamic voltage control of a device. An example system includes: a power management unit configured to dynamically detect one or more operation modes of a plurality of chip components of a device, determine a target operating voltage based at least in part on the detected operation modes, and generate one or more voltage control signals associated with the target operating voltage; an input/output control unit configured to, in response to the one or more voltage control signals, toggle a plurality of input/output pins; and a power management integrated circuit connected to the plurality of input/output pins and configured to change an actual operating voltage of the device to the target operating voltage in response to the toggling of the plurality of input/output pins.

### CROSS-REFERENCE TO RELATED APPLICATIONS

This disclosure claims priority to and benefit from U.S. Provisional Patent Application No, 61/908,421, filed on Nov. 25, 2013, the entirety of which is incorporated herein by reference.

### FIELD

The technology described in this patent document relates generally to electronic devices and more particularly to voltage control

### BACKGROUND

Semiconductor devices are often referred to as “chips.” Some semiconductor devices include microelectronic systems. For example, a system-on-chip (SOC) may include central processing units, input/output interface units, digital signal processors, storage media, etc. Different components of a semiconductor device (i.e., chip components) often require different voltages (e.g., power supply voltages) for proper operations. As an example, on a SOC chip, a low voltage is needed for a digital signal processor, a higher voltage for input/output (I/O) operations, and another voltage for analog circuitry (e.g., phase locked loops).

Battery powered devices, such as mobile phones and portable media players, often include multiple operation modes to conserve battery power. For example, a sleep mode is often employed when the device is not used. In the sleep mode, certain components of the device may be operated at a minimum power. A chip operating voltage supplied to the device may be adjusted to reduce power consumption.

### SUMMARY

In accordance with the teachings described herein, system and methods are provided for dynamic voltage control of a device. An example system includes: a power management unit configured to dynamically detect one or more operation modes of a plurality of chip components of a device, determine a target operating voltage based at least in part on the detected operation modes, and generate one or more voltage control signals associated with the target operating voltage; an input/output control unit configured to, in response to the one or more voltage control signals, toggle a plurality of input/output pins; and a power management integrated circuit connected to the plurality of input/output pins and configured to change an actual operating voltage of the device to the target operating voltage in response to the toggling of the plurality of input/output pins.

In one embodiment, a method is provided for dynamic voltage control of a device. One or more operation modes of a plurality of chip components of a device are dynamically detected. A target operating voltage is determined based at least in part on the detected operation modes. One or more voltage control signals associated with the target operating voltage are generated. In response to the one or more voltage control signals, a plurality of input/output pins connected to a power management integrated circuit are toggled. The power management integrated circuit changes an actual operating voltage of the device to the target operating voltage in response to the toggling of the plurality of input/output pins.

In another embodiment, a circuit for dynamic voltage control of a device includes: a power management unit configured to dynamically detect one or more operation modes of a plurality of chip components of a device, determine a target operating voltage based at least in part on the detected operation modes, and generate one or more voltage control signals associated with the target operating voltage; a plurality of input/output pins connected to a power management integrated circuit; and an input/output control circuit configured to, in response to the one or more voltage control signals, toggle the plurality of input/output pins. The power management integrated circuit is configured to change an actual operating voltage of the device to the target operating voltage in response to the toggling of the plurality of input/output pins.

### BRIEF DESCRIPTION OF THE DRAWINGS

FIG. 1 depicts an example diagram showing a system for dynamic voltage control of a device.

FIG. 2 depicts another example diagram showing a system for dynamic voltage control of a device.

FIG. 3 depicts another example diagram showing a system for dynamic voltage control of a device.

FIG. 4 depicts an example flow chart for dynamic voltage control of a device.

### DETAILED DESCRIPTION

An operating voltage of an electronic device (“a chip”) may be changed using software control to reduce power consumption. For example, a software component may be used to detect operating frequencies of a central processing unit, an advanced extensible interface, and/or double-data-rate memory included on a device. Then, the software component determines an operating voltage according to the detected operating frequencies. However, software components often reside on hardware components, such as an application processor. When the hardware components enter into a low power mode (e.g., a sleep mode), the software components may not function anymore. Thus, in a low power mode, the operating voltage of the device may not be adjusted using the software components to further reduce power consumption.

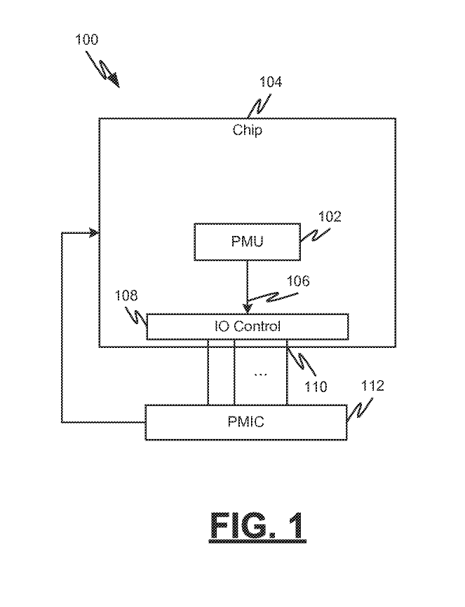

FIG. 1 depicts an example diagram showing a system for dynamic voltage control of a device. As shown in FIG. 1, a power management unit (PMU) 102 detects operation modes of a plurality of chip components of a device 104 to determine a target operating voltage for the device 104, and generates one or more control signals 106 to an input/output control unit 108. A plurality of input/output pins 110 connected to a power management integrated circuit (PMIC) 108 are toggled in response to the control signals 106. The PMIC 108 changes an actual operating voltage of the device 104 to the target operating voltage (e.g., to reduce power consumption).

Specifically, the PMU 102 (e.g., a hardware component) is implemented to dynamically detect the operation modes of the chip components of the device 104. For example, certain logics are incorporated into the PMU 102 for status detection. Operation modes of some chip components or all of the chip components included in the device 104 are detected. The operation modes include one or more active modes associated with one or more active operating voltages and one or more low power modes associated with one or more low power operating voltages. As an example, the PMU 102 determines the target operating voltage to be a maximum of component operating voltages (e.g., active operating voltages, or low power operating voltages) associated with the detected operation modes.

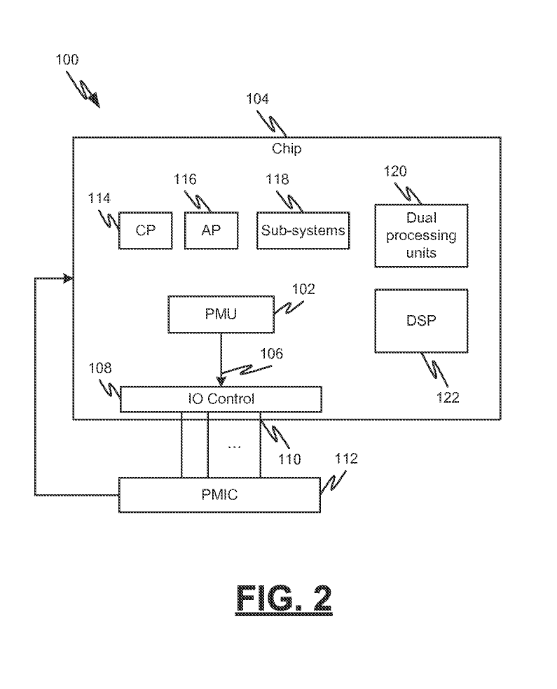

As shown in FIG. 2, the device 104 may include various chip components, such as one or more communications processors 114, one or more application processors 116, dual central processing units 118 (e.g., included in an application processor), application processor subsystems 120, one or more digital signal processors 122, etc. When some or all of chip components operate in low power modes, the device 104 enters into one or more chip-level low power modes (e.g., ultra drowsy retention chip level dormancy).

In some embodiments, the PMU 102 includes a microcontroller (e.g., a microchip) that manages power functions of the device 104. The microcontroller may include firmware, software, memory, a central processing unit, input/output functions, one or more timers, one or more analog to digital converters, etc. In certain embodiments, the PMU 102 coordinates various functions, including: monitoring power connections and battery charges, charging batteries when necessary, controlling power to other integrated circuits, shutting down unnecessary system components that are left idle, controlling sleep and power functions, regulating a real-time clock (RTC), etc. The PMU 102 remains active even when the device 104 is in a chip-level low power mode (e.g., ultra drowsy retention chip level dormancy). Thus, the PMU 102 can dynamically adjust the actual operating voltage according to the operation modes of the chip components even in a chip-level low power mode.

One or more registers may be implemented to store voltage level values corresponding to operation modes of the plurality of chip components of the device 104. For example, during the start up process of the device 104, the registers are initialized with predetermined voltage level values. Upon the detection of the operation modes of the chip components of the device 104, the PMU 102 accesses the registers and determines a target operating voltage by selecting a stored voltage level value that corresponds to the detected operation modes. Then, the PMU 102 generates the control signals 106 according to the target operating voltage.

As an example, a register associated with a chip component includes 32 bits as shown in Table 1.

TABLE 1

| Other control bits | Voting values | |
|---|---|---|
| [31 . . . 12] | [6 . . . 4] | [2 . . . 0] |
| | Voltage level | Voltage level in |
| | in active mode | low power mode |
| | RW | RW |

As shown in Table 1, the first three bits of the register (e.g., [2 . . . 0]) are used to indicate a voltage level in a low power mode, and the other three bits of the register (e.g., [6 . . . 4]) are used to indicate a voltage level in an active mode. These bits are readable and writable. In addition, the register includes other control bits (e.g., [31 . . . 12]. If the PMU 102 detects that the chip component operates in the low power mode, the associated operating voltage is determined based on the first three bits [2 . . . 0] of the register. If the PMU 102 detects the chip component operates in the active mode, the associated operating voltage is determined based on the three bits [6 . . . 4] of the register. In some embodiments, voltage level values stored in certain registers may be updated when operating frequencies of certain hardware components (e.g., double-data-rate memory, graphics cards, visual processing units, etc.) change.

Table 2 shows example registers for storing voltage level values corresponding to various operation modes of the chip components.

TABLE 2

| Register Name | Description |
|---|---|
| DVC_AP | Application Processor Dynamic Voltage |
| | Change Register |
| DVC_CP | Communications Processor Dynamic Voltage |
| | Change Register |
| DVC_DP | Digital Processor Dynamic Voltage Change |
| | Register |
| DVC_APSUB | Application Processor subsystem Dynamic |
| | Voltage Change Register |
| DVC_CHIP | Chip-level Dynamic Voltage Change Register |

In some embodiments, the input/output pins 110 include general purpose input/output (GPIO) pins. GPIO pins can be configured to be input or output, and can be enabled or disabled. Further, input values of GPIO pins are readable. For example, a GPIO pin has a high voltage status that corresponds to “1,” and a low voltage status that corresponds to “0.” Output values of the GPIO pins are writable/readable. In response to the control signals 106, the input/output control unit 108 provides input values (e.g., “1” or “0”) to the input/output pins 110 to toggles the input/output pins 110.

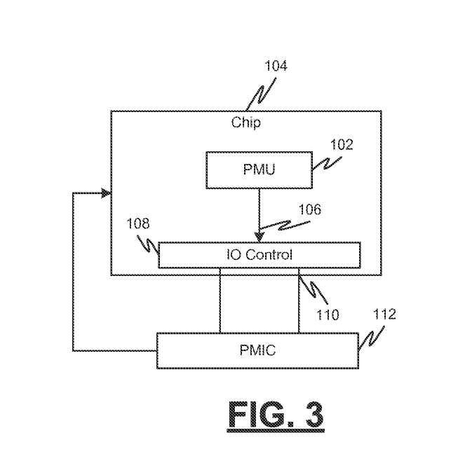

The PMIC 112 changes the actual operating voltage of the device 104 according to the toggling of the input/output pins 110. For example, the input/output pins 110 include two GPIO pins, as shown in FIG. 3. Table 3 shows example different output voltages of the PMIC 112.

TABLE 3

| Input values | Input values | Output |
|---|---|---|
| for Pin 2 | for Pin 1 | voltages |
| 0 | 0 | V1 |
| 0 | 1 | V2 |
| 1 | 0 | V3 |
| 1 | 1 | V4 |

In some embodiments, the PMIC 112 includes one or more integrated circuits or one or more system blocks in a system-on-a-chip device for managing power requirements of the device 104. In certain embodiments, the PMIC 112 includes a DC to DC converter to allow dynamic voltage scaling and/or a switching amplifier (e.g., a Class-D electronic amplifier). The PMIC 112 can implement pulse-frequency modulation (PFM) and pulse-width modulation (PWM).

Referring back to FIG. 2, the PMU 102 detects, for example, that an application processor is in an active mode associated with an active operating voltage, a communications processor is in a low power mode associated with a first low power operating voltage, and a digital signal processor is in a low power mode associated with a second low power operating voltage. Then, the PMU 102 determines the target operating voltage to be the maximum of the active operating voltage, the first low power operating voltage, and the second low power operating voltage.

In some embodiments, a low power mode of an application processor subsystem is deeper (e.g., requiring less power) than a low power mode of an application processor and a low power mode of a communications processor. If the PMU 102 detects that the application processor subsystem, the application processor, and the communications processor all enter into the low power mode, then the PMU 102 only considers the lower power mode of the application processor subsystem for determining the target operating voltage.

In certain embodiments, a chip-level low power mode is deeper (e.g., requiring less power) than a low power mode of an application processor subsystem and a low power mode of a digital signal processor. If the PMU 102 detects that the chip-level low power mode is entered, then the PMU 102 only considers the chip-level low power mode for determining the target operating voltage.

In response to an operation event that changes the operation modes of the chip components, the PMU 102 adjusts the target operating voltage and changes the control signals 106. For example, the device 104 is in a chip-level low power mode. The PMU 102 detects an operation event for activating a communications processor and a digital signal processor and keeping an application processor in a low power mode. Thus, the PMU 102 determines a new target operating voltage to be the maximum of a first active operating voltage associated with the active mode of the communications processor, a second active operating voltage associated with the active mode of the digital signal processor, and a low power operating voltage associated with the low power mode of the application processor.

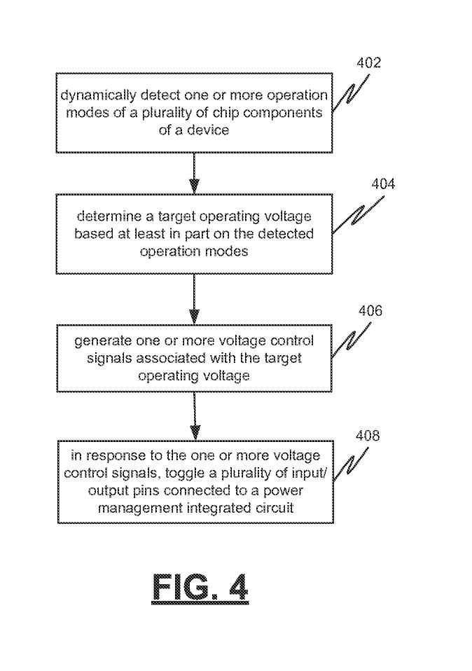

FIG. 4 depicts an example flow chart for dynamic voltage control of a device. At 402, one or more operation modes of a plurality of chip components of a device are dynamically detected. At 404, a target operating voltage is determined based at least in part on the detected operation modes. At 406, one or more voltage control signals associated with the target operating voltage are generated. At 408, in response to the one or more voltage control signals, a plurality of input/output pins connected to a power management integrated circuit are toggled. The power management integrated circuit changes an actual operating voltage of the device to the target operating voltage in response to the toggling of the plurality of input/output pins.

This written description uses examples to disclose the invention, include the best mode, and also to enable a person skilled in the art to make and use the invention. The patentable scope of the invention may include other examples that occur to those skilled in the art. Other implementations may also be used, however, such as firmware or appropriately designed hardware configured to carry out the methods and systems described herein. For example, the systems and methods described herein may be implemented in an independent processing engine, as a co-processor, or as a hardware accelerator. In yet another example, the systems and methods described herein may be provided on many different types of computer-readable media including computer storage mechanisms (e.g., CD-ROM, diskette, RAM, flash memory, computer's hard drive, etc.) that contain instructions (e.g., software) for use in execution by one or more processors to perform the methods' operations and implement the systems described herein.

What is claimed is:

1. A system for dynamic voltage control of a device, the system comprising:
a power management unit configured to dynamically detect one or more operation modes of a plurality of chip components of a device, determine a target operating voltage based at least in part on the detected operation modes, and generate one or more voltage control signals associated with the target operating voltage;
an input/output control unit configured to, in response to the one or more voltage control signals, toggle a plurality of input/output pins; and
a power management integrated circuit connected to the plurality of input/output pins and configured to change an actual operating voltage of the device to the target operating voltage in response to the toggling of the plurality of input/output pins.

2. The system of claim 1, wherein the power management unit is further configured to determine the target operating voltage to correspond to a maximum of component operating voltages associated with the detected operation modes.

3. The system of claim 1, further comprising:
one or more registers configured to store voltage level values corresponding to the operation modes of the plurality of chip components;
wherein the power management unit is further configured to determine the target operating voltage based at least in part on the voltage level values.

4. The system of claim 1, wherein the plurality of chip components include one or more application processors, dual central processing units, application processor subsystems, one or more digital signal processors and one or more communications processors.

5. The system of claim 1, wherein the plurality of input/output pins correspond to general purpose input/output pins.

6. The system of claim 1, wherein an input/output pin is associated with a high voltage status or a low voltage status.

7. The system of claim 1, wherein:
the plurality of input/output pins include a first input/output pin and a second input/output pin; and
the power management unit is further configured to select the target operating voltage from four predetermined voltage levels associated with the first input/output pin and the second input/output pin.

8. The system of claim 1, wherein the power management unit is further configured to detect an operation event for changing the one or more operation modes and adjust the target operating voltage in response to the operation event.

9. The system of claim 1, wherein the operation modes include one or more active modes associated with one or more active operating voltages and one or more low power modes associated with one or more low power operating voltages.

10. A method for dynamic voltage control of a device, the method comprising:
dynamically detecting one or more operation modes of a plurality of chip components of a device;
determining a target operating voltage based at least in part on the detected operation modes;
generating one or more voltage control signals associated with the target operating voltage; and
in response to the one or more voltage control signals, toggling a plurality of input/output pins connected to a power management integrated circuit;
wherein the power management integrated circuit changes an actual operating voltage of the device to the target operating voltage in response to the toggling of the plurality of input/output pins.

11. The method of claim 10, further comprising:
determining the target operating voltage to correspond to a maximum of component operating voltages associated with the detected operation modes.

12. The method of claim 10, further comprising:
storing voltage level values corresponding to the operation modes of the plurality of chip components in one or more registers;
wherein the target operating voltage is determined based at least in part on the voltage level values.

13. The method of claim 10, wherein the plurality of chip components include one or more application processors, dual central processing units, and one or more communications processors.

14. The method of claim 10, wherein the plurality of input/output pins correspond to general purpose input/output pins.

15. The method of claim 10, wherein an input/output pin is associated with a high voltage status or a low voltage status.

16. The method of claim 10, wherein:
the plurality of input/output pins include a first input/output pin and a second input/output pin; and
the method further includes: selecting the target operating voltage from four predetermined voltage levels associated with the first input/output pin and the second input/output pin.

17. The method of claim 10, further comprising:
detecting an operation event for changing the one or more operation modes; and
adjusting the target operating voltage in response to the operation event.

18. The method of claim 10, wherein the operation modes include one or more active modes associated with one or more active operating voltages and one or more low power modes associated with one or more low power operating voltages.

19. A circuit for dynamic voltage control of a device, the circuit comprising:
a power management unit configured to dynamically detect one or more operation modes of a plurality of chip components of a device, determine a target operating voltage based at least in part on the detected operation modes, and generate one or more voltage control signals associated with the target operating voltage;
a plurality of input/output pins connected to a power management integrated circuit; and
an input/output control circuit configured to, in response to the one or more voltage control signals, toggle the plurality of input/output pins;
wherein the power management integrated circuit is configured to change an actual operating voltage of the device to the target operating voltage in response to the toggling of the plurality of input/output pins.

20. The circuit of claim wherein the plurality of input/output pins correspond to general purpose input/output pins.
